(19) United States
(12) Patent Application Publication
(10) Pub. No.: US 2023/0161996 A1
(43) Pub. Date: May 25, 2023

(54) SYSTEMS AND METHODS FOR FEW SHOT PROTEIN GENERATION

(71) Applicant: NE47 Bio, Inc., Hillsborough, NC (US)

(72) Inventor: Tristan Bepler, Singapore (SG)

(21) Appl. No.: 17/989,600

(22) Filed: Nov. 17, 2022

Related U.S. Application Data
(60) Provisional application No. 63/281,975, filed on Nov. 22, 2021.
(60) Provisional application No. 63/321,916, filed on Mar. 21, 2022.

(51) Int. Cl. G06N 3/00; G06N 7/06; G06N 3/08; G06N 20/00

(52) U.S. Cl. CPC G06N 3/002; G06N 7/06; G06N 3/08; G06N 20/00

(57) ABSTRACT

Embodiments described herein provide a new approach to learning generative models of proteins based on sequence-to-sequence learning. Specifically, sequence modeling is formulated as a few-shot learning problem: a single encoder-decoder model receives an input of a protein family which is encoded into a protein representation and the protein representation is then decoded into a distribution over sequences from that family. The model is trained on tens of thousands of multiple sequence alignments representing known protein families and evaluated on unseen families heldout from training.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCES

This application is related to co-pending and commonly owned U.S. Provisional Application Nos. 63/281,975, filed Nov. 22, 2021, and 63/321,916, filed Mar. 21, 2022, both of which are hereby expressly incorporated by reference herein in their entirety.

### TECHNICAL FIELD

The present disclosure relates generally to protein sequencing and generation designs, and more specifically, to few-shot protein generation using knowledge learnt from a protein family.

### BACKGROUND

Proteins are composed of sequences of amino acid sequences. The unique amino acid sequencing may determine or render a unique property of a protein, e.g., an antibody, a virus, and/or the like. Protein sequencing is the practical process of determining the amino acid sequence of all or part of a protein or peptide, which can be used to identify the protein or characterize its post-translational modifications. On the other hand, designing an amino acid sequence may be used to generate a protein with certain desired properties. However, the number of amino acids for protein sequencing is significantly large, resulting in exponentially increased complexity in determining probable sequences for protein generation.

Therefore, there is a need for an efficient mechanism to design protein sequences.

### BRIEF DESCRIPTION OF THE DRAWINGS

FIG. 1 is a simplified diagram illustrating an overall architecture of few-shot protein generation using a generative model, according to one or more embodiments described herein.

FIG. 2A is a simplified diagram illustrating an exemplary structure of the encoder described in FIG. 1, according to one or more embodiments described herein.

FIG. 2B is a simplified pseudo-code segment illustrating an operation performed by the transformer encoder with axial attention shown in FIG. 2A, according to one or more embodiments described herein.

FIG. 3A is a simplified diagram illustrating an exemplary structure of the decoder described in FIG. 1, according to one or more embodiments described herein.

FIG. 3B is a simplified pseudo-code segment illustrating an operation performed by the transformer decoder with cross attention shown in FIG. 3A, according to one or more embodiments described herein.

FIG. 4 is a simplified diagram illustrating an example of protein sequence generation using an example MSA query matrix, according to one or more embodiments described herein.

FIG. 5 is a simplified logic flow diagram illustrating a method of few-shot protein generation using the encoder and the decoder described in FIGS. 1-4, according to one or more embodiments described herein.

FIG. 6 is a simplified diagram of a computing device for implementing the few shot protein generation, according to some embodiments.

FIGS. 7-14 provide various data results of data experiments to illustrate example performance of the few shot protein generation model described in FIGS. 1-6.

In the figures and appendix, elements having the same designations have the same or similar functions.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

Protein engineering is the task of mutating proteins in order to achieve a desired function, and has numerous applications in medicine and sustainability. Designing such mutations can often be challenging, because inferring protein functional impact from protein structure is difficult, and the search space of possible sequence variants is combinatorialy large. For example, a given mutation could cause a disproportionate effect due to being positioned within an active site or long-range interactions with other amino acids. In addition, introducing multiple mutations simultaneously can have complex non-linear effects, called epistasis.

Machine learning systems have been adopted for protein sequencing analysis and/or generation. For example, a machine learning system may be trained on a dataset of protein properties and the corresponding protein structure of amino acid sequences. The machine learning system can then be used to predict an amino acid sequence for protein generation, given one or more desired protein properties. The machine learning system used for protein generation is herein referred to as a “generative model.”

In another aspect, supervised training data on the functional impact of protein mutants is also limited. Acquiring supervised data means performing complicated and costly deep mutational scanning experiments. Generally, these experiments characterize the functional impact of point mutations, so experimental data on the impact of higher order mutants can be even more scarce. On the other hand, the number of variants that can be measured is limited by the assay throughput. For typical functional activity assays, this can restrict the number of feasibly measurable variants to hundreds or less.

In contrast, sequence data is plentiful for natural proteins. The number of known natural protein sequences has nearly tripled in the last 5 years, and continues to grow rapidly due to the falling cost of DNA sequencing. However, one issue in biological sequence analysis is to take a set of sequences representing a protein family, fit a generative model to those sequences, and then use the resulting model to search databases and classify new proteins. In this setting, families are usually represented by sets of sequences (e.g., in a multiple sequence alignment (MSA) query matrix), a protein structure, and/or the like. Thus the task is to find the parameters of a generative model, given protein information for a family that describes the family and generalizes to unseen members. Existing sequence models used for this problem includes position-specific scoring matrices (PSSMs) or profile Hidden Markov Models (pHMMs). For example, PSSMs model each column in the MSA as independent distributions over amino acids. Profile HMMs model each amino acid as being generated conditioned on a hidden state corresponding to the column in the MSA, but this alignment is considered unobserved when calculating the probability of a new sequence. The PSSM and HMM models are widely used, because they can be inferred from relatively small sets of sequences (often only 10 s or 100 s) and parameter inference needs to be performed for each set of proteins of interest.

In view of the learning limitations in protein engineering, embodiments described herein provide a system for building generative models of proteins based on sequence-to-sequence learning. Specifically, sequence modeling is formulated as a few-shot learning problem such that a single encoder-decoder model is trained to receive and encode information of a protein family. The information can take a form of an amino acid sequence, a set of amino acid sequences that belong to the same protein family, a multiple sequence alignment (MSA) matrix, a protein structure, and/or the like. The information of a protein family may be used as input to an encoder which encodes the information into protein representation, which is then decoded into a probability distribution over sequences from that protein family. In other words, the encoder-decoder model outputs a sequence that possibly represents a new protein for the protein family conditioned on learned encoding of the input protein information of the protein family. In this way, the encoder-decoder model may be trained to handle different protein families, circumventing the need for fitting dedicated family models.

In one embodiment, the encoder-decoder model may be trained on tens of thousands of protein sequencing information. In some implementations, the protein sequencing information may be input in the form of sequences of tokens. In another implementation, the protein sequencing information may be learnt in the form such as MSAs representing known protein families and then may receive unseen families held out from training at inference stage.

In this way, the generative encoder-decoder model learns to infer statistical sequence models of proteins that are substantially more accurate (lower perplexity) than PSSMs and pHMMs without requiring training on new protein families. Instead, the proposed generative model extrapolates directly from the multiple sequence alignment and learns how to infer evolutionary constraints from the training families.

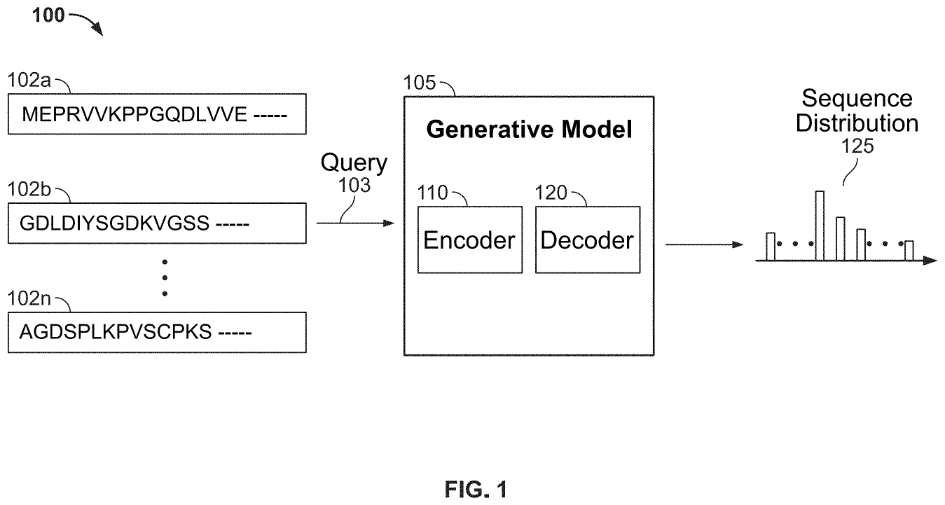

FIG. 1 is a simplified diagram 100 illustrating an overall architecture of few-shot protein generation using a generative model, according to one or more embodiments described herein. Diagram 100 shows a set of protein sequences, such as 102a-n, may be fed to a generative model 105 as an input. For example, the set of protein sequences 102a-n may represent proteins from the same family, which may be input to the generative model 105 in the form of a multiple sequence alignment (MSA) query 103. The MSA query 103 may take the form of a N×M matrix, representing N protein sequences and M columns. The MSA query matrix 103 includes a plurality of tokens x_{i,j}, i ∈ 1, . . . N, j ∈ 1, . . . M, each of which denotes the amino acid or gap token at the j′th position of the i′th sequence.

In one embodiment, the generative model 105 may generate, in response to the input MSA query 103 (denoted by X), a probability distribution 125 over target protein sequences (y's), e.g., p(y|X). The target protein sequences are a set of possible protein sequences in the same protein family of the input sequences 102a-n. Thus, the generative model 105 is trained by a training set of (MSA, target protein) pairs (X^{k}, y^{k}) where k ∈ 1, . . . , K denotes the kth pair. For example, the target protein y^{k} is a member of the same family as the sequences in X^{k} that does not comprise the same target protein sequence y^{k}.

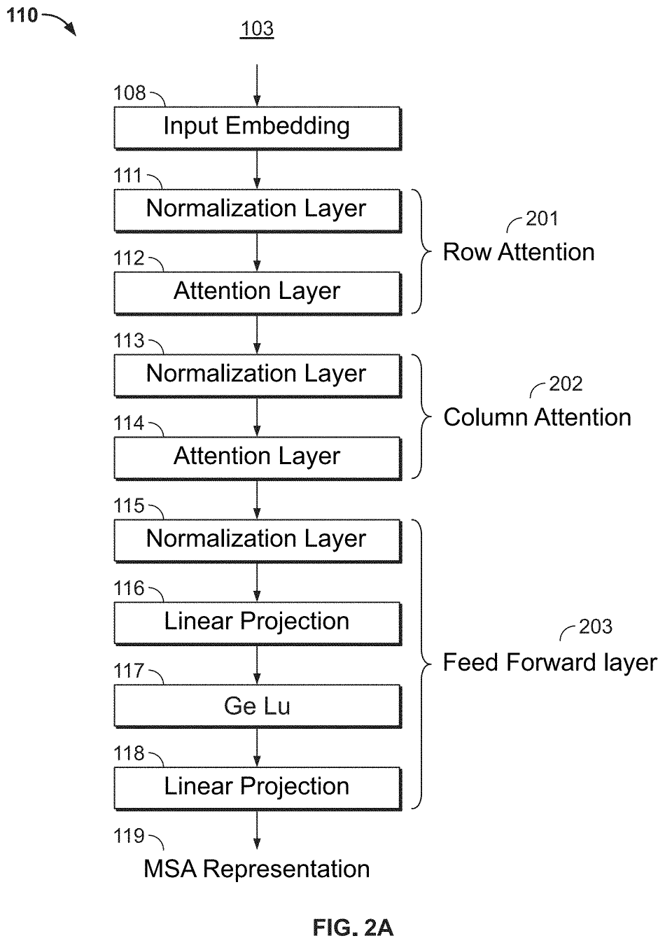

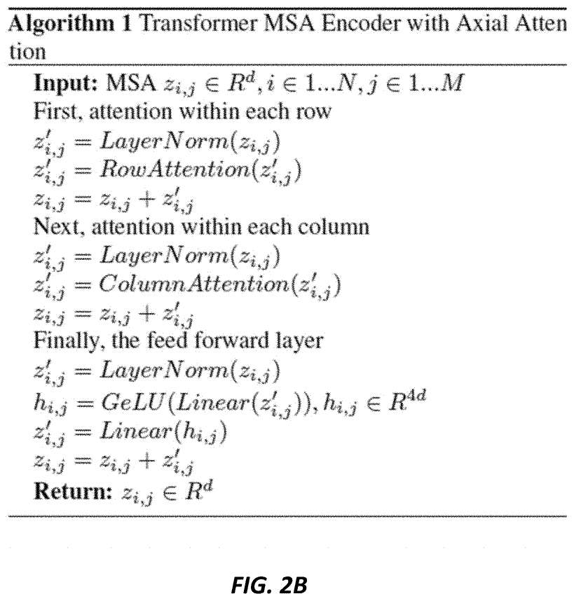

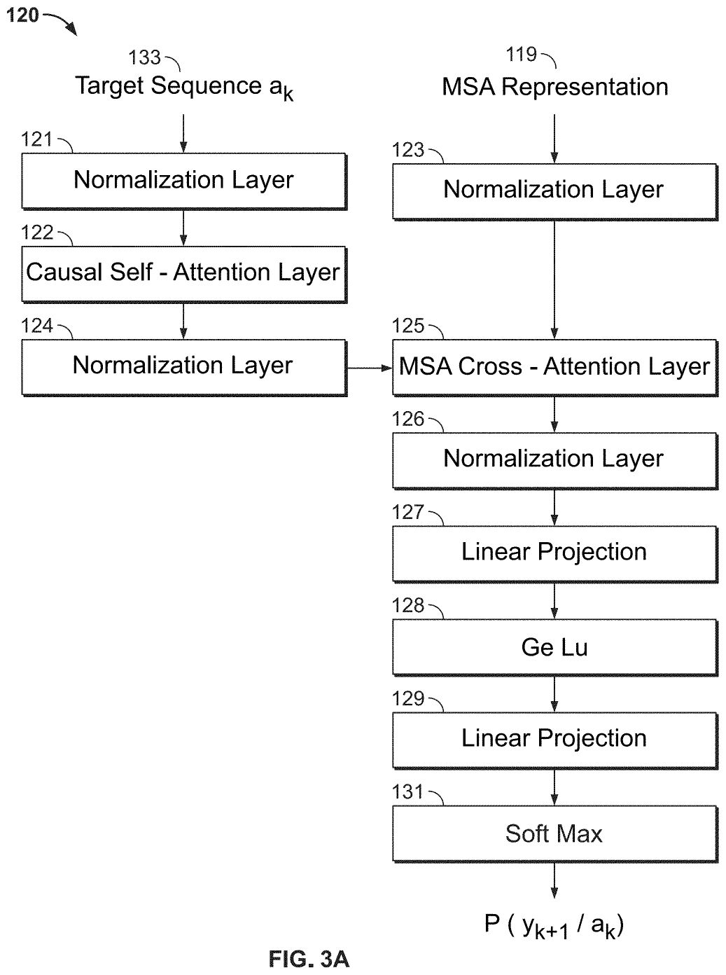

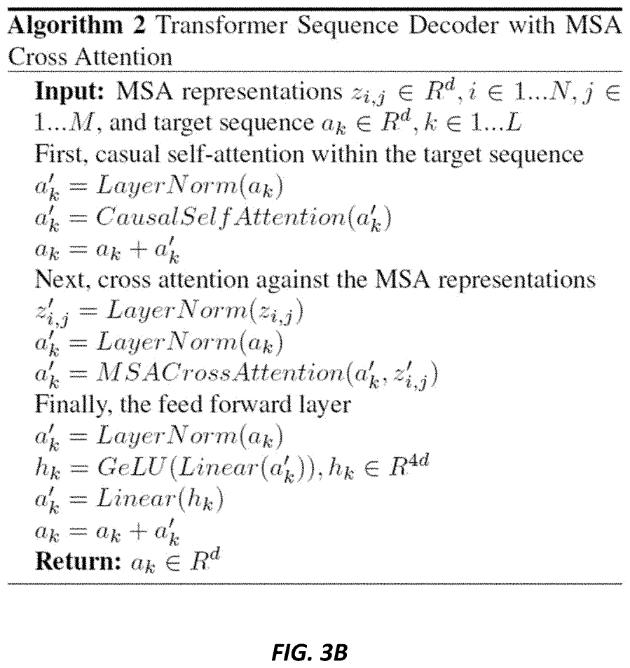

In one embodiment, the generative model 105 may be a transformer model that comprises an MSA-encoder 110 and a sequence-to-sequence decoder 120 neural network architecture. The detailed structures of the encoder 110 and the decoder 120 are described in relation to FIGS. 2-3, respectively.

It is noted that the example embodiment shown in FIG. 1 uses the MSA query matrix as an example input structure to the protein generative model 105. Other forms of protein information such as a set of amino acid sequencing, protein structures, and/or the like, can be applied to a similar generative model structure shown in FIG. 1.

FIG. 2A is a simplified diagram illustrating an exemplary structure of the encoder 110 described in FIG. 1, according to one or more embodiments described herein. In the embodiment described in FIG. 2A, an input of MSA query matrix 103 is considered. The MSA encoder 110 may be a transformer encoder that applies axial self-attention on the rows (e.g., see the row attention layer 201) and columns (e.g., see the column attention layer 202), into context-aware vector representations, z_{i,j} (e.g., via a feed forward layer 203), for each token x_{i,j} in the MSA query 103.

In one embodiment, the MSA encoder 110 accepts tokens x_{i,j} in the MSA query 103 as input and returns a vector representation 119 for each position in the MSA query, z_{i,j} ∈ R^{d}, where d is the dimension of the learned embedding. The MSA encoder 110 is parameterized as a stack of transformer layers for axial attention over the rows 201, axial attention over the columns of the MSA 202 and a feed forward layer 203.

Before being processed by the transformer stack, the input tokens x_{i,j} are preprocessed by an input embedding module 108 which embed the input tokens into vectors in R^{d} and augmented with a random Fourier projection of the column index as a positional embedding, also in R^{d}. No positional embedding is used for the rows of the MSA (the sequence index), because the ordering of sequences in an MSA is arbitrary and the MSA encoder 110 is expected to be invariant to the specific ordering of sequences in the input.

Specifically, the input embedding module 108 forms the input embeddings by adding a learned embedding for each amino acid to the random Fourier feature embedding of the column index as follows. First, the amino acid token is embedded by learned embeddings:

x_{i,j}^{aa}=W_{xi,j},x_{i,j}^{aa}∈R^{d},W ∈R^{K×d}

where W is a matrix of learnable amino acid embeddings of dimension d, K is the size of the vocabulary (22 in the case of 20 amino acids plus gap and start/end tokens), and x_{i,j} indicates the amino acid at position i, j of the MSA. Next, the column index is embedded by:

x_{i,j}^{pos}=W^{pos} cos(rj+b),x_{i,j}^{pos}∈R^{d},r ∈R^{d},b ∈R^{d},W^{pos}∈R^{d×d},

where W^{pos} is a learnable matrix, r is a random vector drawn from Normal(0, 1), and b is a random vector drawn from Uniform(0, 2π). The input embedding is then formed by:

z_{i,j}=x_{i,j}^{aa}+x_{i,j}^{pos}.

The MSA encoder transformer layers comprise axial self-attention layers 201-202 along the rows and columns of the MSA matrix 103 followed by a fully connected feed forward layer 203. The row-attention layer 201 comprises a normalization layer 111 and an attention layer 112 such that the axial row attention is preceded by layer normalization and uses residual connections. Similarly, the column-attention layer 202 comprises a normalization layer 113 and an attention layer 114 such that the axial column attention is preceded by layer normalization and uses residual connections. The feed forward layer 203 comprises a normalization layer 115, a linear projection layer 116, a GeLu layer 117 and another linear projection layer 118.

FIG. 2B is a simplified pseudo-code segment illustrating an operation performed by the transformer MSA encoder with axial attention shown in FIG. 2A, according to one or more embodiments described herein. As shown in FIG. 2B, the attention within each row is computed and accumulated. Then the attention within each column is computed and accumulated. And finally, the feed forward layer applies a GeLU operation to accumulate the output from the GeLu operation.

Therefore, within row and within column attention can be computed efficiently by calculating the multi-headed attention operation over the rows or columns batch-wise. For example, given a batch of intermediate MSA representations, Z, with dimensions B×N×M×d, where B is the number of MSA queries in the batch, N is the number of rows in each MSA query matrix, and M is the number of columns in each MSA query matrix, and d is the size of the input embedding of the MSA query, per-row self-attention can be calculated by treating rows as part of the batch dimension, BN×M×d, and then per column self-attention can be calculated by treating columns as part of the batch dimension, BM×N×d.

FIG. 3A is a simplified diagram illustrating an exemplary structure of the decoder 120 described in FIG. 1, according to one or more embodiments described herein. In the embodiment described in FIG. 2B, a MSA representation 119 encoded from an input of MSA query matrix 103 is considered. The decoder 120 may comprise a set of sequence decoder transformer layers, which apply causal self-attention to the target sequence 133, cross-attention to the MSA representations 119, and then applies fully connected layers with layer normalization and residual connection for each block. Specifically, the transformer decoder is configured to apply a causal self-attention mask to ensure that the output representation for each position of the sequence in the decoder is only a function of previous positions in the target sequence 133 and the MSA representation 119.

In one embodiment, before being passed into the decoder transformer layers, the target sequence aₖ is embedded following the same scheme as the input embedding module 108 for the MSA along the column dimension. When decoding, the target sequence is padded to begin with a start token and end with a stop token.

The embedded and padded target sequence aₖ is then sent to a normalization layer 121, followed by the causal self-attention layer 122 followed by another normalization layer 124. Meanwhile, the MSA representations 119 are sent to a normalization layer 123. The outputs from normalization layers 123 and 124 are then sent to the MSA cross-attention layer 125, which generates cross-attentions between the self-attentions of the target sequence and the MSA representations. Specifically, in the MSA cross attention layer 125, each position of the target sequence attends over the complete MSA representations for each attention head (i.e., L×N×M×H, where L is the number of target sequences, and His the number of heads). The cross-attentions can thus be efficiently computed by flattening the MSA representations along the row and column dimensions such that each MSA representation, z_{i,j}, is a single key in the cross attention layer 123. The cross-attentions are then sent to the feed forward layer, which in turn applies a normalization layer 126, a linear projection 127, a GeLu operation 128, another linear projection 129.

FIG. 3B is a simplified pseudo-code segment illustrating an operation performed by the transformer MSA decoder 120 with cross attention shown in FIG. 3A, according to one or more embodiments described herein. As shown in FIG. 3B, the causal self-attention within the target sequence is computed and accumulated for each token in the target sequence. Then the cross attention against the MSA representations is computed and accumulated. And finally, the feed forward layer applies a GeLU operation to accumulate the output from the GeLu operation.

Decoding the target sequence is performed using the decoder representations by learning a transformation from aₖ to the probability distribution over the (k+1)th token. This decoding process is formulated as a linear transformation of aₖ into a vector of dimension equal to the number of tokens, followed by softmax 131 to give the probability of each token, p(yₖ₊₁|aₖ)=p(yₖ₊₁|y₁, . . . ,ₖ, X).

The decoding process may be applied to yield different outputs. The decoder may generate, based on the probability of each token, token by token, a new protein sequence different from any of the plurality of amino acid sequences in the MSA query matrix but belongs to the same protein family. For another example, given a specific protein sequence, the decoder may determine a score indicating a likelihood level that the given protein sequence belongs to the same protein family. In another example, give a number of sampled protein sequences, the decoder may determine, based on the decoded probabilities, a recommended protein sequence that has the highest likelihood to belong the protein family among a number of given protein sequences.

In this way, the encoder-decoder model may be trained to generate predicted protein sequence in a sequence-from-sequences manner. For example, the decoder may generate predicted sequences in a protein family conditioned on previously generated sequences that belong to the family.

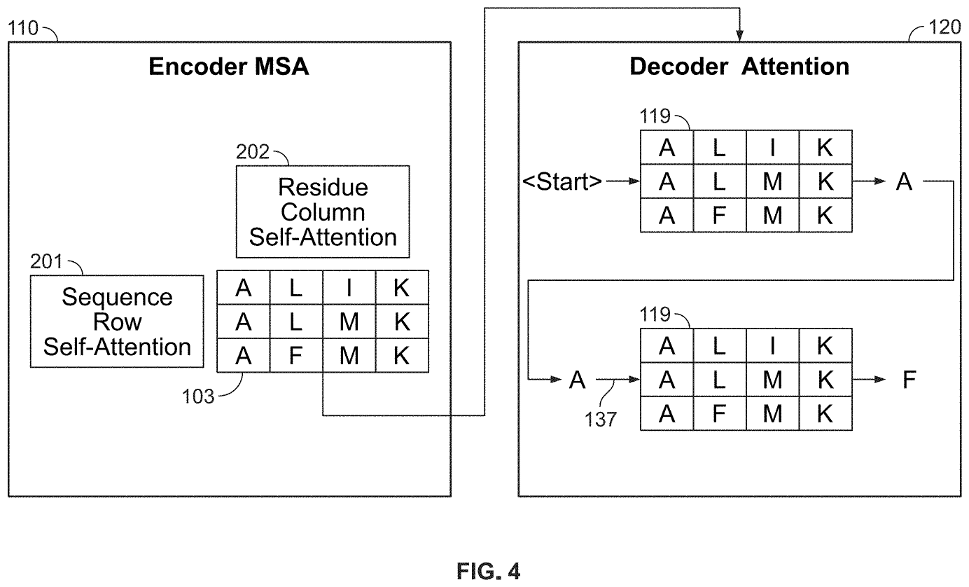

FIG. 4 is a simplified diagram illustrating an example of protein sequence generation using an example MSA query matrix 103, according to one or more embodiments described herein. As shown in FIG. 4, the example MSA query matrix 103 may be applied with self-attentions at the encoder 110. Sequence row self-attention 201 may be applied within each row (e.g., the row of “A, L, M, K”), and residual column self-attention 202 may be applied to each column (e.g., the column of “L, L, F”) of the MSA query matrix 103 to result in MSA representations for each token in the matrix 103.

At the decoder 120, the target sequence may be padded with a start token<end> and an end token<end>, and be applied with a causal self-attention. The self-attentions 137 (e.g., corresponding to token “A”) may then be applied with cross attention against the MSA representations 119 to result in the output probability over the next token (e.g., “F”) in the target sequence.

It is noted that the example embodiments described in relation to FIGS. 2A-4 use the MSA query matrix as an example input structure to the protein generative model 105. Other forms of protein information such as amino acid sequencing, protein structures, and/or the like, can be applied to a similar generative model structure shown in FIGS. 2A-4.

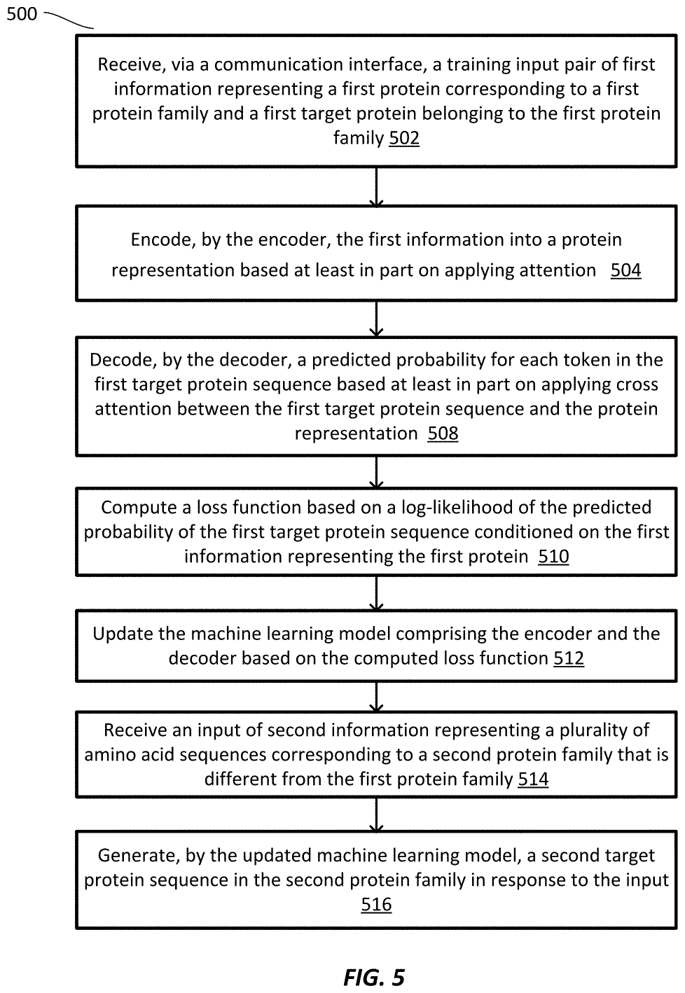

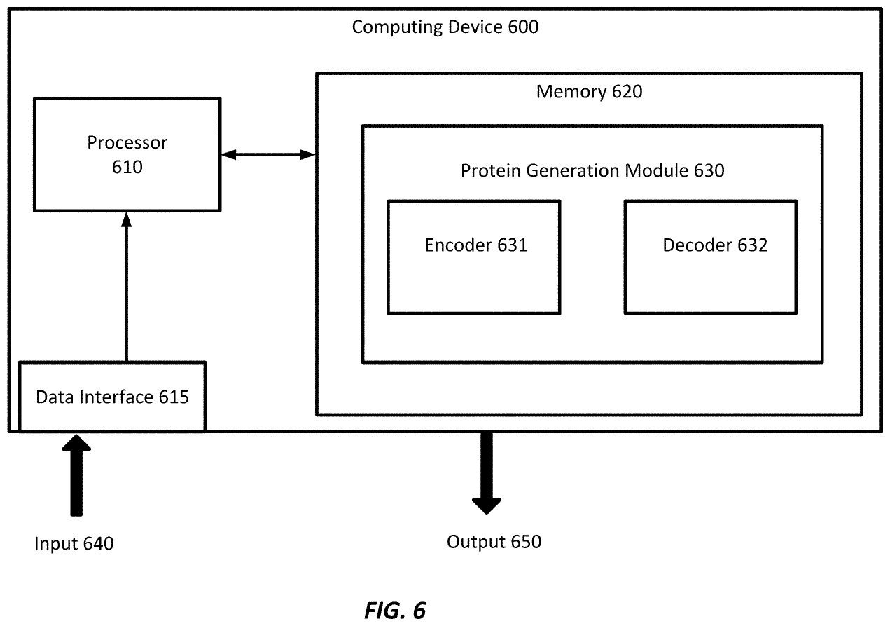

FIG. 5 is a simplified logic flow diagram illustrating a method of few shot protein generation using the encoder 110 and the decoder 120 described in FIGS. 1-4, according to one or more embodiments described herein. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operation of the protein generation module 630 (FIG. 6) to perform model training and few-shot protein generation.

At step 502, a training input pair of first information representing a first protein belonging to a first protein family and a first target protein belonging to the first protein family is received. In one implementation, the first information representing the first protein may include an amino acid sequencing, a first multiple sequence alignment (MSA) query matrix (e.g., 103 in FIG. 1) representing a plurality of amino acid sequences, a protein structure, and/or the like. The training data may be received via a communication interface (e.g., see data interface 615 in FIG. 6). The first target protein sequence is different from any of the plurality of amino acid sequences but belongs to the first protein family. For example, as shown in FIG. 4, the MSA query matrix 103 has a number of rows representing the plurality of protein sequences, and each entry in the MSA query matrix represents an amino acid token in a respective row of protein sequence.

In one implementation, high-performing mutants may be sampled from the first protein family as the first target protein sequence for training the encoder and the decoder.

In one implementation, an input embedding of entries for the training data may be generated. For example, when the training input includes an MDS query matrix, a first embedding is generated for each amino acid token in the MSA query matrix, and a second embedding is generated based on a random feature embedding of a column index of the MSA query matrix. The input embedding is then formulated by adding the first embedding and the second embedding.

In another example, the training pair may be obtained from full Pfam family alignments. In order to evaluate the performance of the model on unseen families, the Pfam sequences at the family level may be split into 10,593 training, 563 validation, and 2,654 test families.

At step 504, an encoder (e.g., 110 in FIGS. 1 and 2A) of the machine learning model may encode the first information representing the first protein (e.g., a MSA query matrix 103 in FIG. 1) into a protein representation (e.g., MSA representation 119 in FIG. 2A) based at least in part on applying attention within each row and each column of the first MSA query matrix. For example, row attentions (e.g., 201 in FIG. 2A) may be generated over a first set of amino acid tokens within each row of the MSA query matrix. Column attentions (e.g., 202 in FIG. 2A) may be generated over a second set of amino acid tokens within each column of the MSA query matrix. A feed-forward layer (e.g., 203 in FIG. 2A) may generate a context-aware vector representation from the computed row attentions and the computed column attentions.

At step 508, a decoder (e.g., 120 in FIGS. 1 and 3A) may decode a predicted probability for each token in the first target protein sequence (e.g., 133 in FIG. 3A) based at least in part on applying cross attention between the first target protein sequence and the protein representation (e.g., MSA representation 119 in FIG. 3A). For example, causal self-attentions may be generated within a set of amino acids in the target protein sequence. Cross attentions may be generated between the generated causal self-attentions corresponding to the target protein sequence and vector entries of the MSA representation. A feed-forward layer may generate a probability for a next amino acid token conditioned on previously decoded amino acid tokens in the target protein sequence.

At step 510, a loss function may be computed based on a log-likelihood of the predicted probability of the first target protein sequence conditioned on the first information representing the first protein (e.g., MSA query matrix 103 in FIG. 1). In one implementation, the parameters of the model are fit to minimize the negative log-likelihood of the target sequences conditioned on their family MSAs. Given K MSA, target sequence pairs, this loss is:

$$ℒ = - {{\sum }^{K}}_{i = 1} \text{?} log p ( {y}_{k}^{i} \vert {y}_{1 … k - 1}^{i} , {X}^{i} ) . \\ \text{?} \text{indicates text missing or illegible when filed}$$

At step 512, the machine learning model comprising the encoder and the decoder may then be updated based on the computed loss function, e.g., via backpropagation. For example, the machine learning model is trained with the following specific hyperparameters: six encoder and decoder layers each with hidden dimension (d) of 768. The MSA encoder uses 12 attention heads and the decoder uses 8 attention heads.

In one implementation, the training may adopt ADAM variant of stochastic gradient descent using a linear ramp up, square root decay learning rate scheduler using a learning rate of 0.0001 with 4,000 warmup steps. A total minibatch size of 256 spread over 16 GPUs using distributed training. Each GPU process minibatches of size 1 with gradient accumulation over 16 steps to give the total effective minibatch size. In order to reduce GPU RAM consumption, sequences and MSAs are randomly sampled to a maximum length of 402 tokens during training. Furthermore, MSAs are randomly downsampled to contain between 1 and 50 sequences. During training, the loss is monitored on a validation set of MSAs and stop training when the validation loss stops decreasing.

At step 514, an input of second information (e.g., a second MSA query matrix) representing a plurality of amino acid sequences corresponding to a second protein family that is different from the first protein family may be received.

At step 516, the updated machine learning model may generate a second target protein sequence in response to an input of a second protein that belongs to a second protein family that is different from the first protein family. In this way, the trained machine learning model may be used to predict the protein sequences in the second protein family without re-training using sequencing data corresponding to the second protein family.

FIG. 6 is a simplified diagram of a computing device for implementing the few-shot protein generation, according to some embodiments. As shown in FIG. 6, computing device 600 includes a processor 610 coupled to memory 620. Operation of computing device 600 is controlled by processor 610. And although computing device 600 is shown with only one processor 610, it is understood that processor 610 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 600. Computing device 600 may be implemented as a stand-alone subsystem, as a board added to a computing device, and/or as a virtual machine.

Memory 620 may be used to store software executed by computing device 600 and/or one or more data structures used during operation of computing device 600. Memory 620 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 610 and/or memory 620 may be arranged in any suitable physical arrangement. In some embodiments, processor 610 and/or memory 620 may be implemented on a same board, in a same package (e.g., system-in-package), on a same chip (e.g., system-on-chip), and/or the like. In some embodiments, processor 610 and/or memory 620 may include distributed, virtualized, and/or containerized computing resources. Consistent with such embodiments, processor 610 and/or memory 620 may be located in one or more data centers and/or cloud computing facilities.

In some examples, memory 620 may include non-transitory, tangible, machine readable media that includes executable code that when run by one or more processors (e.g., processor 610) may cause the one or more processors to perform the methods described in further detail herein. For example, as shown, memory 620 includes instructions for a protein generation module 630 that may be used to implement and/or emulate the systems and models, and/or to implement any of the methods described further herein. In some examples, the protein generation module 630, may receive an input 640, e.g., such as a set of protein sequences belonging to a protein family, represented by an MSA query 103 via a data interface 615. The protein generation module 630 may generate an output 650 (such as predicted probabilities of tokens in a target protein sequence) in response to the input 640.

The protein generation module 630 may comprise an encoder 631 (e.g., similar to encoder 110 in FIGS. 1-4) and a decoder 632 (e.g., similar to decoder 120 in FIGS. 1-4). The encoder 631 receives an input of a protein sequence and encoded it with axial self-attention on the rows and columns into a context-aware vector representation. For example, when the input is a MSA query matrix, the encoder 631 may include a stack of transformer layers with axial attention over the rows and columns of the MSA query matrix.

The decoder 632 then decodes the target sequence from the representations by attending to the learned representations in a decoder transformer with cross attention to the encoded protein representation. For example, when the decoder 632 receives an MSA representation from the encoder 631, the decoder 632 may comprise causal self-attention, cross-attention layers to apply to the MSA representations.

Some examples of computing devices, such as computing device 600 may include non-transitory, tangible, machine readable media that include executable code that when run by one or more processors (e.g., processor 610) may cause the one or more processors to perform the processes of method. Some common forms of machine readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

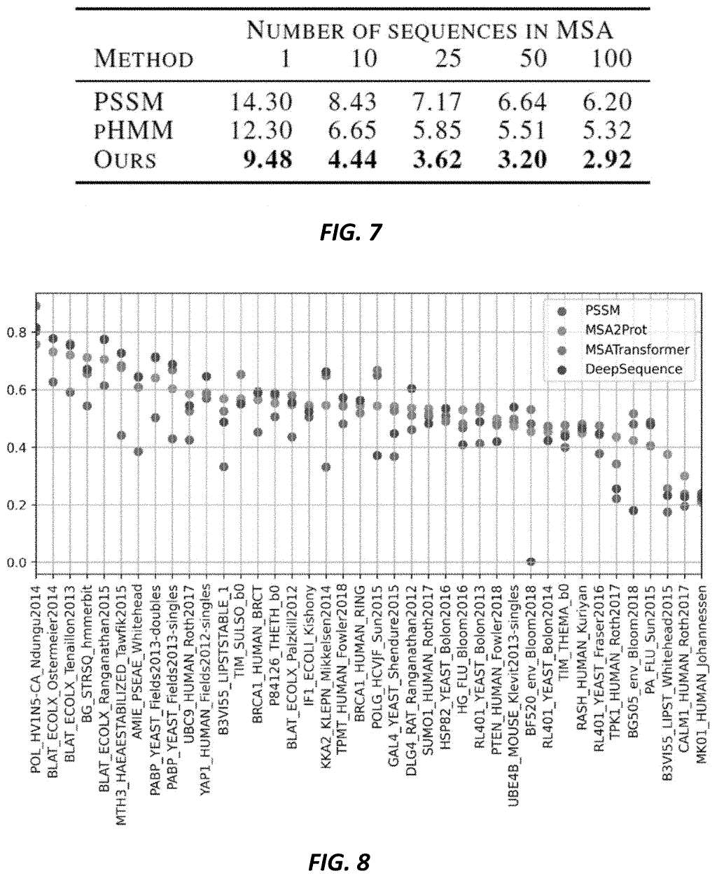

FIGS. 7-14 provide various data results of data experiments to illustrate example performance of the few shot protein generation model described in FIGS. 1-6. First, the ability of the generative model to generate new proteins by generalizing from few protein sequences representing a protein family to unseen members of the family is tested. The perplexity of sequences in the validation set families is computed given an increasing number of randomly selected observed members, not including the target sequence. This allows to understand the ability of the model to extrapolate evolutionary landscapes from a small number of observations. The model is then compared with two widely used protein statistical sequence models: position-specific scoring matrices (PSSMs) and profile HMMs (pHMMs).

As expected, it is observed that all models' ability to generalize to unseen family members improves as the number of observed family members increases as shown in FIG. 7. Furthermore, the model dramatically outperforms PSSMs and profile HMMs across all MSA sizes. Remarkably, the model scales much better with additional data, even outperforming PSSMs and pHMMs with 10× fewer sequences. This demonstrates that the model learns how to extrapolate from small number of sequences by better capturing evolutionary priors over sequences.

A major challenge in protein engineering is navigating the enormous search space of possible sequence variants, because the space of sequence variants increases exponentially with the number of sites. For example, if all 20 amino acids at 10 positions are considered, the number of unique sequences is 2010 which is greater than ten trillion. At 65 sites, the space of possible sequences exceeds the number of atoms in the universe. However, the vast majority of these variants are not functional (<1% in typical mutagenesis experiments). Therefore, homing in on only the space of viable protein variants is critical for efficiently and feasibly searching sequence space. Perplexity represents the number of amino acids that would need to be guessed from uniformly to find the correct amino acid, therefore, it is the size of the reduced alphabet learned by the model. On this basis, the model can produce an enormous reduction in library size for protein engineering. Using the 10 sites example, the pHMM perplexity of 5.3 yields a library size of 18 million which the model reduces to only 42,000, more than an order of magnitude reduction in library size over the pHMM and about 8 orders of magnitude better than random search. This improvement is even more extreme when considering more sites for mutation.

Compared to the masked language models described, the generative model (denoted as “MSA2Prot”) offers exact sampling through the use of a decoder. This sidesteps computationally intensive Gibbs sampling.

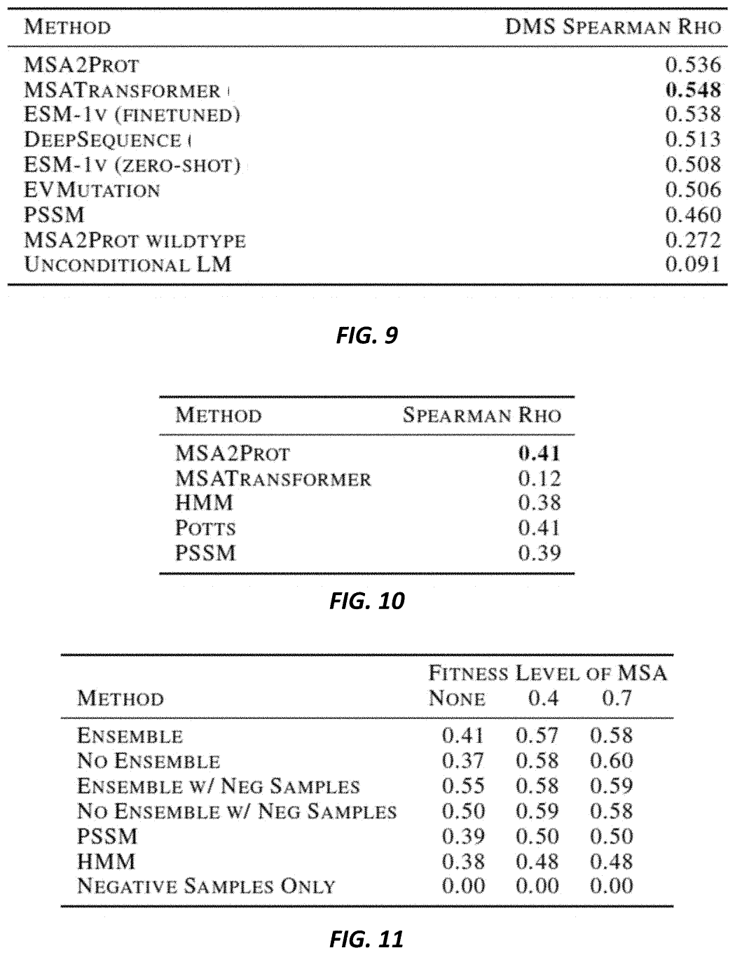

FIGS. 8-9 show evaluation results of the model on the protein mutation datasets developed by Riesselman et al., Deep generative models of genetic variation capture the effects of mutations, Nat. Methods, 15(10):816-822, October 2018. These datasets consist of mostly single mutant deep mutational scans, and a few double mutant deep mutational scans. As a baseline, the model is compared to an unconditional language model trained on the same dataset and MSA2Prot predictions with only the wild-type sequence. The plot further compared to state-of-art methods for protein fitness prediction, including PSSMs, pHMMs, EVmutation, DeepSequence, ESM-1v, and MSATransformer. PSSMs estimate the probability of each amino acid at a given position and assume independence between different positions. EVmutation is a Potts model that estimates the pairwise interaction terms between residues. pHMMs model amino acids as being generated conditioned on a hidden state of the respective MSA column. DeepSequence trains a generative model on a large multiple sequence alignment for a given protein. ESM-1v and MSATransformer are masked language models, where ESM-1v models protein sequences whereas MSATransformer models multiple sequence alignments. Compared to the above methods, MSA2Prot displays stateof-art performance. Comparisons with the unconditional language model as well as the wild-type only MSA2Prot predictions indicate that the inclusion of the MSA is a key driver of this performance. The averages across the datasets are shown in FIG. 9, and a dataset-specific breakdown is shown in FIG. 8.

FIGS. 10-13 illustrate results of data experiments on higher order mutants. Given that 37 of above 40 DMS datasets consist of single mutants, the model is evaluated on a dataset of chorismite mutase sequences (Russ et al., An evolution-based model for designing chorismate mutase enzymes. Science, 369(6502):440-445, July 2020). This dataset is highly diverse, with sequence divergence in the test set ranging from 14 percent to 82 percent. The model outperforms MSATransformer substantially, as shown in FIG. 10. This is likely because MSATransformer uses additive scoring to assess the likelihood of higher order mutants, whereas MSA2Prot's decoder is able to exactly model epistasis.

In addition, MSA2Prot is able to generalize from a distribution of high-performing mutants, as shown in FIG. 11. Spearman rho on the test set dramatically improves after the training MSA is filtered to include only a few hundred high-performing sequences. Lastly, MSA2Prot is able to harness low-performing variants to significantly improve accuracy. Although these low performing variants have no predictive power on their own, they can be used as negative samples by subtracting the likelihood of a sequence from the low-performing MSA from the likelihood of a sequence from a standard MSA.

Often, combing the literature for a given protein will yield a list of high and low performing mutants. However, given that experimental setups differ, there may not be consistent fitness measurements. MSA2Prot is an ideal candidate for this situation, given its ability to harness both high and low performing variants without explicit functional measurements. MSA2Prot also offers exact generation conditioned on multiple attributes. Given a protein sequence, the probability distribution over the next residue can be obtained by adding and re-normalizing the marginals of two MSAs, each representing different attributes.

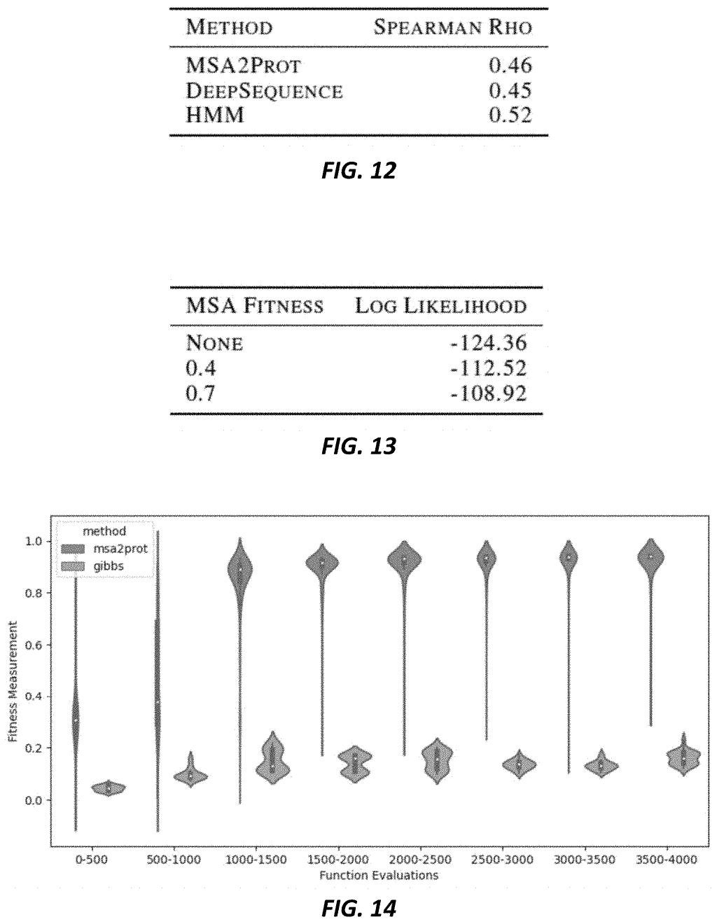

MSA2Prot is further evaluated on the data set (Gonzalez et al., Fitness effects of single amino acid insertions and deletions in term-1-lactamase. Journal of Molecular Biology, 431(10):2320-2330, May 2019) of 262 deletions and 4422 insertions, and benchmarked against (Riesselman et al., 2018) and an HMM. FIG. 12 indicates that MSA2Prot achieves comparable performance with (Riesselman et al., 2018), even though it does not require retraining.

FIGS. 13-14 show example results of data experiments that adopt adaptive sampling with the model. In addition to offering high predictive accuracy through its log-likelihood, MSA2Prot is able to generatively extrapolate from high-performing mutants. The high performing sequences in the test set become several orders of magnitude more likely as the training MSA is filtered to include higher performing variants. This result is shown by FIG. 13.

MSA2Prot's ability to adaptively sample high fitness variants given black-box oracle, approximated by a Random Forest Regressor. For example, the system may randomly sample 100 sequences from the training MSA to form an initial MSA. Sequences are sampled, and update the MSA if the regressor predicts the sampled sequence has a higher fitness than the minimum fitness sequence in the MSA. The results, shown in FIG. 14, indicate that MSA2Prot is able to effectively generate strong mutants. MSA2Prot initially generated sequences with a fitness of 0.3, which is the 56th percentile of the training distribution. After several thousand updates, MSA2Prot generated sequences with a fitness of 0.9, which is in the 89th percentile of the training distribution. For comparison, Gibbs sampling initially generated a sequence with a fitness of 0.03, which is in the 39th percentile of the training distribution. After the same number of function evaluations, Gibbs sampling generated a sequence with fitness 0.3, which is in the 56th percentile of the training distribution. Thus, MSA2Prot displayed considerably stronger performance. Compared to standard adaptive sampling methods, MSA2Prot offers the benefit of not requiring training. Instead, MSA2Prot relies on its few-shot generalization abilities. Thus, MSA2Prot offers a computationally efficient alternative for protein sequence design.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A system for using a machine learning model of few-shot protein generation, comprising:
a memory storing an encoder and a decoder, and a plurality of processor-executable instructions; and
a processor executing the plurality of processor-executable instructions to:
obtain a multiple sequence alignment (MSA) query matrix representing a plurality of amino acid sequences corresponding to a protein family;
transform, by the encoder, the MSA query matrix into a MSA representation based at least in part on applying attention within each row and each column of the MSA query matrix;
decode, by the decoder, a probability for each token in a protein sequence belonging to the protein family based at least in part on applying cross attention between the protein sequence and the MSA representation; and
transmitting, based on decoded probabilities, information relating to a protein sequence to a protein synthesis module for synthesizing a target protein.

2. The system of claim 1, wherein the MSA query matrix has a number of rows representing the plurality of protein sequences, and each entry in the MSA query matrix represents an amino acid token in a respective row of protein sequence.

3. The system of claim 1, wherein the processor further executes the plurality of processor-executable instructions to generate an input embedding of entries in the MSA query matrix by:
generating a first embedding for each amino acid token in the MSA query matrix;
generating a second embedding based on a random feature embedding of a column index of the MSA query matrix; and
formulate the input embedding by adding the first embedding and the second embedding.

4. The system of claim 1, wherein the encoding comprises:
generating row attentions over a first set of amino acid tokens within each row of the MSA query matrix;
generating column attentions over a second set of amino acid tokens within each column of the MSA query matrix; and
generating, via a feed-forward layer, a context-aware vector representation from the computed row attentions and the computed column attentions.

5. The system of claim 1, wherein the row attentions or the column attentions are computed by a multi-headed attention operation over respective rows or columns in a batch.

6. The system of claim 1, wherein the decoding comprising:
generating causal self-attentions within a set of amino acids in the protein sequence;
generating cross attentions between the generated causal self-attentions corresponding to the protein sequence and vector entries of the MSA representation; and
generating, via a feed-forward layer, a probability for a next amino acid token conditioned on previously decoded amino acid tokens in the protein sequence.

7. The system of claim 1, wherein the processor further executes the plurality of processor-executable instructions to:
generate, based on decoded probabilities, the protein sequence that is a new protein sequence different from any of the plurality of amino acid sequences but belongs to the protein family.

8. The system of claim 1, wherein the processor further executes the plurality of processor-executable instructions to:
determining, based on coded probabilities, a score indicating a likelihood level of the protein sequence belonging to the protein family.
determining a likelihood that a given.

9. The system of claim 1, wherein the processor further executes the plurality of processor-executable instructions to:
determining, based on coed probabilities, a recommended protein sequence that has a highest likelihood to belong the protein family among a number of given protein sequences.

10. The system of claim 1, wherein the encoder and the decoder are trained based on a set of MSA query matrices that belong to a first protein family, and wherein the processor further executes the plurality of processor-executable instructions to generate, using the trained encoder and the trained decoder, a protein sequence based on a testing input relating to protein sequences that belong to a second protein family without re-training the encoder or the decoder using sequencing data corresponding to the second protein family.

11. A method of using a machine learning model for few-shot protein generation, comprising:
receiving, via a communication interface, a training input pair of information representing a first protein belonging to a first protein family and information representing a first target protein belonging to the first protein family;
generating, via the machine learning model, a predicted probability of the first target protein in response to an input of the information representing the first protein;
computing a loss function based on a log-likelihood of the predicted probability of the first target protein conditioned on the first protein;
updating the machine learning model based on the computed loss function; and
generating, by the updated machine learning model, information representing a second target protein belonging to a second protein family in response to an input of information representing a second protein that belongs to the second protein family that is different from the first protein family.

12. The method of claim 11, wherein the information representing the first protein comprises any combination of:
an amino acid sequence;
a multiple sequence alignment (MSA) query matrix has a number of rows representing a plurality of protein sequences, and each entry in the MSA query matrix represents an amino acid token in a respective row of protein sequence; and
a protein structure.

13. The method of claim 11, further comprising generating an input embedding of the information representing the first protein by:
generating a first embedding for each amino acid token in the information representing the first protein;
generating a second embedding based on a random feature embedding of the information representing the first protein; and
formulate the input embedding by adding the first embedding and the second embedding.

14. The method of claim 11, wherein the information representing the first protein is a MSA query matrix, and wherein the method further comprising:
generating, via the machine learning model, the predicted probability comprises encoding the MSA query matrix by:
generating row attentions over a first set of amino acid tokens within each row of the MSA query matrix;
generating column attentions over a second set of amino acid tokens within each column of the MSA query matrix; and
generating, via a feed-forward layer, a context-aware vector representation from the computed row attentions and the computed column attentions.

15. The method of claim 14, wherein the row attentions or the column attentions are computed by a multi-headed attention operation over respective rows or columns in a batch.

16. The method of claim 14, further comprising:
generating, via the machine learning model, the predicted probability comprises decoding a probability for each token in a target protein sequence by:
generating causal self-attentions within a set of amino acids in the target protein sequence;
generating cross attentions between the generated causal self-attentions corresponding to the target protein sequence and vector entries of the MSA representation; and
generating, via a feed-forward layer, a probability for a next amino acid token conditioned on previously decoded amino acid tokens in the target protein sequence.

17. The method of claim 11, wherein the information representing the first protein comprises an input of a multiple sequence alignment (MSA) query matrix and the target protein sequence forming a training pair, and
wherein the target protein sequence is different from any of the plurality of amino acid sequences but belongs to the first protein family.

18. The method of claim 11, further comprising:
sampling a high-performing mutant from the first protein family as the first target protein for training the encoder and the decoder.

19. The method of claim 11, wherein the updated machine learning model generates the second target protein without re-training using sequencing data corresponding to the second protein family.

20. A non-transitory processor-readable storage medium storing processor-executable instructions of using a machine learning model for few-shot protein generation, the processor-executable instructions being executed by one or more processors to perform operations comprising:
receiving, via a communication interface, a training input pair of information representing a first protein belonging to a first protein family and information representing a first target protein belonging to the first protein family;
generating, via the machine learning model, a predicted probability of the first target protein in response to an input of the information representing the first protein;
computing a loss function based on a log-likelihood of the predicted probability of the first target protein conditioned on the first protein;
updating the machine learning model based on the computed loss function; and
generating, by the updated machine learning model, information representing a second target protein belonging to a second protein family in response to an input of information representing a second protein that belongs to the second protein family that is different from the first protein family.
